(19) United States
(12) Patent Application Publication
(10) Pub. No.: US 2017/0215993 A1
(43) Pub. Date: Aug. 3, 2017

(54) Orthodontic extraoral traction appliance

(71) Applicant: Marco Migliorati, Rapallo (GE) (IT)

(72) Inventors: Marco Migliorati, Rapallo (GE) (IT); Samuele Grillo, Milano (IT); Lina Altomare, Milano (IT)

(21) Appl. No.: 15/328,787

(22) PCT Filed: Jul. 23, 2015
(86) PCT No.: PCT/IB2015/055579

§ 371 Date: Jan. 24, 2017

(30) Foreign Application Priority Data
Jul. 25, 2014 (IT) GE2014A000072

(51) Int. Cl. A61C 7/06; G01L 1/22; G01L 5/10; G01L 1/16; A61C 7/12; A61C 7/00

(52) U.S. Cl. CPC A61C 7/065; A61C 7/12; A61C 7/002; G01L 5/10; G01L 1/16; G01L 1/22; A61C 2201/007

(57) ABSTRACT

An orthodontic extraoral traction appliance includes at least one central body, one or more rest portions to be positioned on the patient's head, and one or more traction portions, which engage an intraoral brace. The appliance is provided with one or more sensors for detecting and/or measuring the force exerted by the traction portions.

The present invention relates to an orthodontic extraoral traction appliance, comprising at least one central body, one or more rest portions on the patient head and one or more traction portions, which traction portions engage an intraoral brace.

This type of orthodontic appliances are currently known and used for correcting important malocclusion problems. The intraoral brace for example can be a fixed orthodontic brace or a palatal expander, for example a so called Delaire facemask having two hooks at the canine teeth where the traction portions can be connected, which traction portions typically comprise elastic bands.

The most common extraoral traction treatment is that used for correcting antero-posterior discrepancies.

A first type of appliances comprises face masks used for correcting skeletal malocclusions of patients in skeletal class III, that is having a mandibular prognathism. The therapy aims at moving the maxillary complex forward and downwards.

Such type of appliance has to be used by the patient by putting it on the forehead and chin and it is connected to an intraoral fixed brace by elastic bands.

The documents US 2012/0148970 A1 and U.S. Pat. No. 8,640,710 B2 describe embodiments of face masks, focusing the attention to the patient comfort.

A second type of appliances comprises extraoral appliances called as headgear, that aim at slowing or stopping the jaw from growing and therefore preventing or correcting mandibular prognathism.

The documents WO 97/12299 A1 and U.S. Pat. No. 3,648,372 describe extraoral headgear appliances of such type.

These orthodontic appliances have to be worn by the patient at least for 12-14 hours each day for generating the desired skeletal effects.

The elastic bands exert a force ranging from 200 to 500 grams per side.

Therefore these are very hard and annoying treatments for the patient, and this is the reason why efforts are made for improving the patient comfort.

A limit of such therapy, which is only partially solved by increasing the comfort, is the risk that the patient turns out to be not much collaborative, by not wearing the appliance for the required time. In this case, if the use is not extended for the required hours, the desired effects are not achieved, actually making the therapy useless.

In the currently known appliances the physician has no type of control to verify whether the appliance has been really worn, whether it has been worn for the necessary time, and whether the traction portions have exerted the proper force.

The present invention aims at overcoming these limits of the currently known appliances, by an appliance such as described hereinbefore, which is further provided with one or more sensors for detecting and/or measuring the force exerted by the traction portions.

Thus the appliance is provided with sensors of different type that can record the moment when the patient wears the mask and/or record the force applied by the traction portions. The recording of the moment when the patient wears the mask and the recording of the force applied by the traction portions can be performed advantageously but not exclusively contemporaneously.

In one embodiment the traction portions comprise elastic bands fastened to the central body, engaging with corresponding hooks provided in the intraoral brace.

Such elastic bands can be suitably dimensioned for exerting the desired traction force.

As an alternative or in combination the traction portions comprise elements made of a shape memory material fastened to the central body, engaging with corresponding hooks provided on the intraoral brace.

This has the great advantage of allowing an exerted traction force to be constant and not intermittent.

In one preferred embodiment the shape memory material is composed at least partially of a Nickel-Titanium alloy. It is possible to provide other similar shape memory alloys.

In one embodiment the sensors comprise pressure sensors provided into at least one rest portion.

This allows the traction force exerted by the traction portions to be indirectly measured, by measuring the corresponding force exerted by the rest portions on the patient head. The pressure sensors detect the pressure state of the rest portions. This very advantageously allows the evaluation of the pressure state to be used for determining whether the appliance is worn or not. The pressure sensors therefore can be used autonomously even only to evaluate when and how long the appliance has been worn by the patient. As an alternative or in combination the pressure sensors are used for measuring the traction force exerted by the traction portions. Moreover as an alternative or in combination the measurement of the traction force exerted by the traction portions is carried out by means of further sensors, placed for example at the traction portions. In this case it is possible to use the evaluation of the pressure state of the rest portions carried out by the pressure sensors as the activation for the measurement of the traction force exerted by the traction portions by the further sensors. This means that the measurement of the traction force is activated only when the pressure sensors detect that the appliance has been worn.

In a further embodiment one or more said sensors are provided in proximity of the area coupling the traction portions to the central body.

In a first embodiment, the sensors comprise piezoelectric sensors.

In a second embodiment, as an alternative or in combination, the sensors comprise strain gauges.

In a third embodiment, as an alternative or in combination, the sensors comprise pyroelectric sensors, namely sensitive to a temperature change.

In a fourth embodiment, as an alternative or in combination, the sensors comprise force-sensitive resistors.

According to an improvement there is provided a control unit receiving as input the data detected by the sensors.

In one embodiment the control unit is provided with means comparing the values detected by the sensors with threshold values and/or with ranges of reference values.

The reference values can be decided by the manufacturer and set in the manufacturing step, or it is possible to provide a setting unit for the user.

According to one embodiment there is provided an acoustic and/or visual signalling unit receiving as input the data by the control unit and generating an alarm signal if the values exceed the threshold values and/or fall outside the ranges of reference values.

Thus it is possible to shown the patient or physician the correctness of the force exerted by the appliance and/or whether daily hours necessary for the treatment have been reached.

In a further embodiment there is provided a unit storing the data detected by said sensors, that receives as input the data from the control unit.

Thus data can be saved for being later analyzed.

In a further embodiment there is provided a remote communication unit for data detected by said sensors, that receives as input the data from the control unit.

This allows data to be sent to a remote device such as a pc, a tablet, a smartphone and/or in real time to a server accessible by the physician or a specialized body.

In one embodiment there is provided a web-based application for displaying data sent by the remote communication unit.

By means of this application, provided with selective access by means of credentials, the physician, parent, patient and/or another registered user can get the access to the data detected by the sensors. Such data can be displayed in the form of diagrams, values (force, pressure, etc), calculated values (duration, increase in using the appliance, etc.).

According to one embodiment, there are provided means for setting the force exerted by the traction portions.

Such means for example can comprise a spring with settable tension interposed between a rest portion and a traction portion, or between two separated parts of the same rest portions.

In a preferred embodiment the force setting means comprise a ring nut provided with a spring, preferably a helical spring, the ring nut being rotatable between two extreme angle positions for increasing or decreasing the tension of the spring.

It is possible to provide sensors detecting the tension of the spring, for example torsional or linear strain gauges, for measuring the force applied by the spring.

The detected tension is displayed in an analogue manner, for example by an angle scale shown on the ring nut, or in a digital manner, for example by lighting a series of leds or by means of a LCD monitor.

In a variant embodiment the appliance is composed of a face mask for correcting skeletal malocclusions in skeletal class III, wherein the central body is composed of at least one curved bar, provided in proximity of the opposite ends with a rest portion on the patient forehead and a rest portion on the patient chin respectively, it being provided in an intermediate region with an element for coupling the traction portions.

Preferably the face mask comprises a single curved bar, but is can also comprise two or more curved bars placed side by side.

In a further variant embodiment the appliance is a orthodontic extraoral traction appliance comprising two central bodies intended to be arranged on the opposite sides of the patient head, which central bodies are connected together by one or more rest portions intended to cooperate with the back and/or the top of the patient head, the central bodies being connected to the traction portions.

These and other characteristics and advantages of the present invention will be more clear from the following description of some embodiments shown in the annexed drawings wherein:

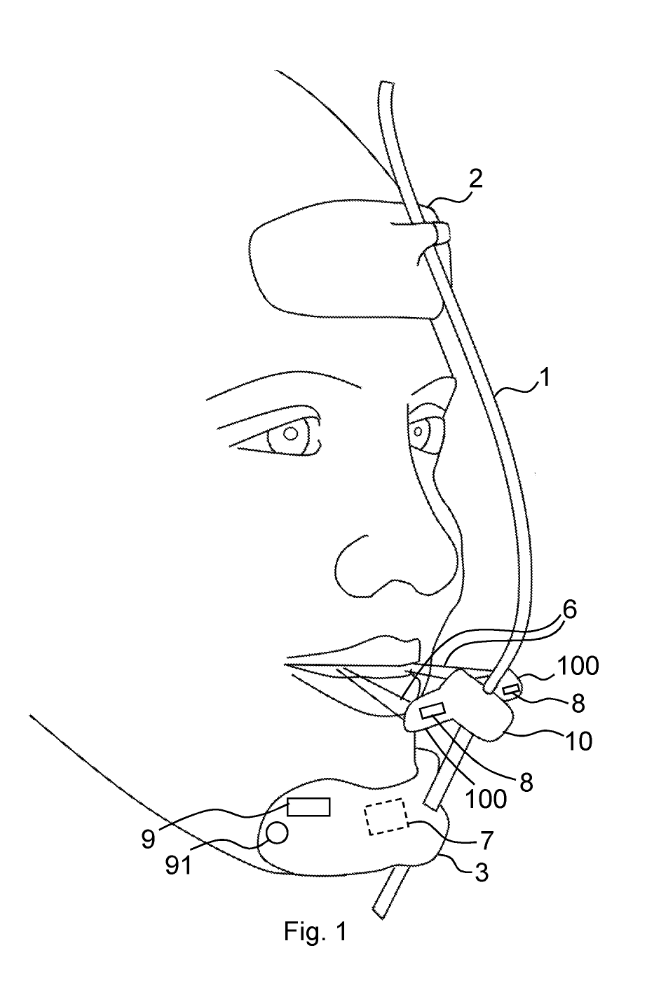

FIG. 1 is a first embodiment of the appliance;

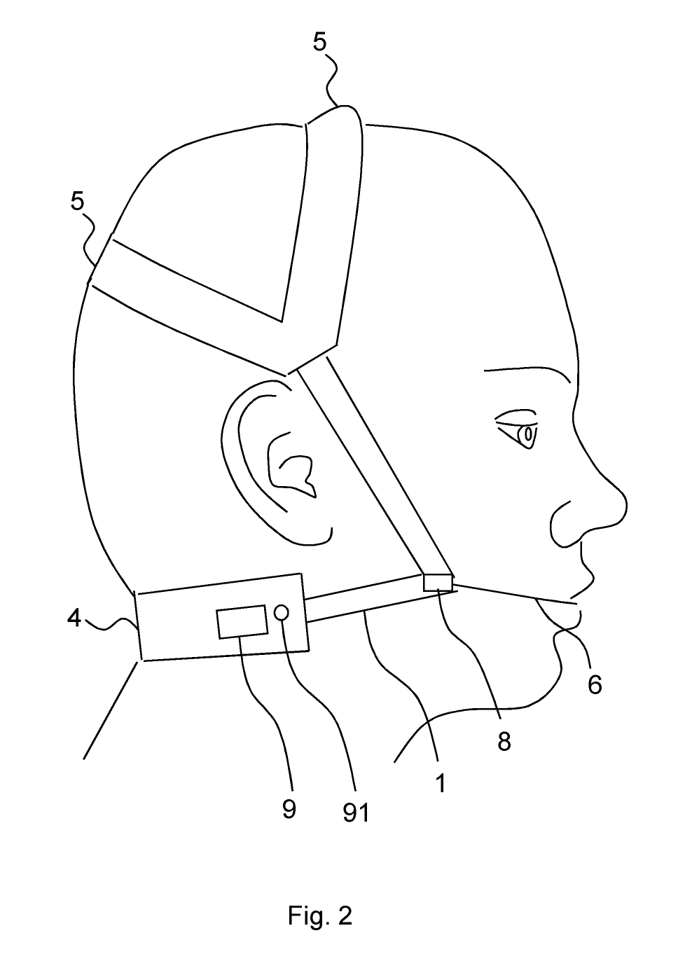

FIG. 2 is a second embodiment;

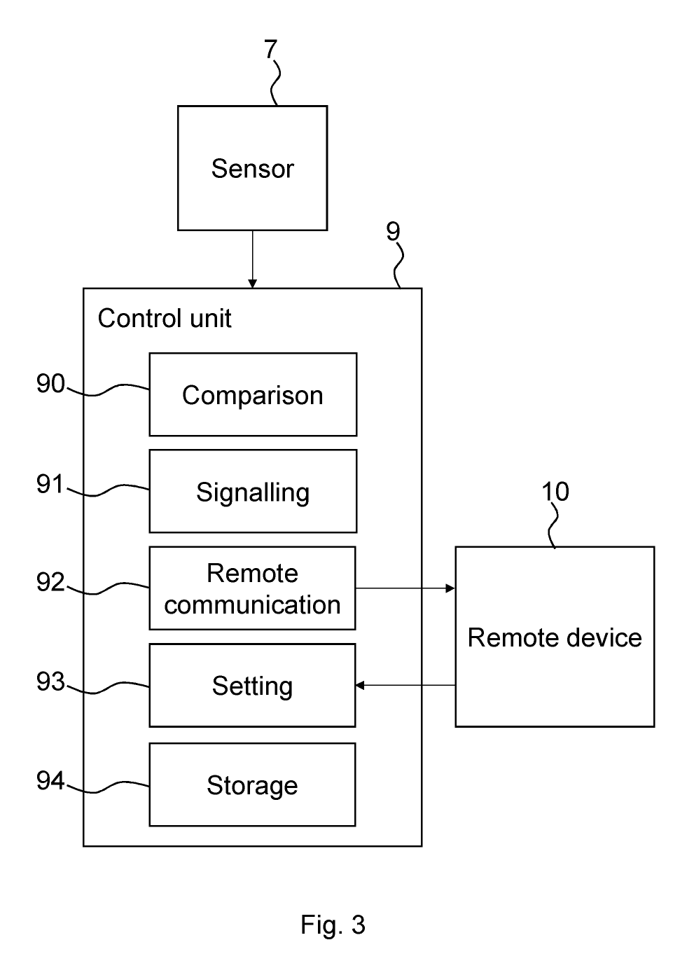

FIG. 3 is a functional block diagram.

FIG. 1 shows a first embodiment of the present invention relating to a face mask for correcting skeletal malocclusions in skeletal class III.

The face mask comprises a single central body composed of a curved bar 1, provided in proximity of the opposite ends with a rest portion 2 on the patient forehead and a rest portion 3 on the patient chin respectively.

The bar 1 is provided in an intermediate region with an element 10 coupling the traction portions, in the example of FIG. 1 it is composed of elastic bands 6. The elastic bands 6 engage an intraoral brace, not shown in the figures.

As set forth above, as an alternative or in combination the traction portions comprise elements made of a shape memory material, such as for example Nickel-Titanium alloy or similar shape memory alloys.

The coupling element 10 is provided with two side arms 100 extending in opposite directions along an axis perpendicular to the bar, at whose ends the traction elastic bands 6 being coupled. Such arrangement allows the elastic bands 6 to be placed at the hooks provided in proximity of the canine teeth on the intraoral brace.

The appliance is provided with one or more sensors for detecting and/or measuring the force exerted by the traction portions.

In the example of the figure there is provided a pressure sensor 7 incorporated into the rest portion 3 on the patient chin 3. In a variant embodiment, that can be carried out in combination or as an alternative, it is possible to provide a further pressure sensor in the rest portion 2 on the patient forehead.

There are further provided sensors 8 placed in proximity of the area connecting the traction portions to the central body, in particular along the arms 100 of the element 10 connecting the elastic bands 6 to the bar 1.

The sensors can be strain gauges or piezoelectric sensors and/or pyroelectric sensors, force-sensitive resistors or other types of similar sensors.

The sensors are in communication with a control unit 9, that receives as input the detected data. Preferably the control unit is placed in the rest portion 3 on the chin 3. There is provided a signalling unit 91, preferably comprising warning lights of different type for showing the patient or physician information about the use of the mask, such as for example the fact of having reached the hours necessary for the treatment.

The sensors can record the moment when the patient wears the mask and the force applied by the elastic bands 6.

FIG. 2 shows a second embodiment, wherein the appliance is an orthodontic extraoral traction appliance comprising two central bodies 1 intended to be arranged on the opposite sides of the patient head, which central bodies 1 are connected together by a rest portion 4 intended to cooperate with the back of the patient neck and of two rest portions 5 intended to cooperate with the head top. The central bodies are connected to the traction portion or “headgear” 6.

A sensor 8 is placed on each central body 1 in proximity of the coupling area of the traction portion 6. As an alternative or in combination it is possible to provide further sensors placed in the rest portions 4 and 5.

The control unit 9 and the signalling unit 91 in the example in the figure are provided in the rest portion 4 intended to cooperate with the back of the patient neck, but they can be provided in the central body 1 or in the rest portion 5 intended to cooperate with the head top.

FIG. 3 shows a functional block diagram of the appliance of the present invention, showing a sensor 7 placed in communication with the control unit 9 for transmitting the detected data.

The control unit is provided with a unit comparing the values detected by the sensors with threshold values and/or with ranges of reference values.

In the example in the figure there is provided a unit 93 for the user to set the threshold values and/or the ranges of the reference values.

A acoustic and/or visual signalling unit 91 is provided generating a warning signal if the values exceed the threshold values and/or fall outside the ranges of the reference values. The signalling unit 91 can comprise one or more LEDs, that can be of different colours or can take different colours depending on the results of the comparison. The signalling unit 91 further can comprise a buzzer for acoustically signalling an alarm or the proper use of the appliance. In one embodiment the signalling unit comprises a display showing the countdown of the residual time necessary for the therapy in the day.

A unit 94 is provided for storing the data detected by the sensors 7, which data can be saved in order to be later analyzed. The storage unit 94 can comprise a removable support, such as for example a MicroSD card.

There is further provided a remote communication unit for the data detected by the sensors 7, such to send the data to a remote device 10. At the same manner the remote device 10 can interface with the setting unit 93 for remotely adjust the operation of the control unit 9 and of the further units.

The invention claimed is:

1. An orthodontic extraoral traction appliance, comprising:
at least one central body (1);
one or more rest portions (2, 3, 4, 5) to be positioned on a patient's head;
one or more traction portions (6), which engage an intraoral brace; and
one or more sensors (7, 8) detecting and/or measuring a traction force exerted by the traction portions (6).

2. The orthodontic extraoral traction appliance according to claim 1, wherein the traction portions (6) comprise elastic bands fastened to the central body (1), said elastic bands engaging with hooks provided in the intraoral brace.

3. The orthodontic extraoral traction appliance according to claim 1, wherein the traction portions (6) comprise elements made of a shape memory material fastened to the central body (1), said elements engaging hooks provided in the intraoral brace.

4. The orthodontic extraoral traction appliance according to claim 3, wherein the shape memory material is composed at least partially of a Nickel-Titanium alloy.

5. The orthodontic extraoral traction appliance according to claim 1, wherein the sensors (7, 8) comprise pressure sensors provided inside at least one of the rest portions (2, 3, 4, 5).

6. The orthodontic extraoral traction appliance according to claim 5, wherein at least one of said sensors (7, 8) are provided in proximity of an area coupling the traction portions (6) to the central body (1).

7. The orthodontic extraoral traction appliance according to claim 6, wherein the pressure sensors are adapted to carry out an evaluation of a pressure state of the rest portions (2, 3, 4, 5), whereby said evaluation is used as an activation to measure the traction force exerted by the traction portions (6) by the sensors provided in the proximity of the area coupling the traction portions (6) to the central body (1).

8. The orthodontic extraoral traction appliance according to claim 1, wherein the sensors (7, 8) comprise piezoelectric sensors.

9. The orthodontic extraoral traction appliance according to claim 1, wherein the sensors (7, 8) comprise strain gauges.

10. The orthodontic extraoral traction appliance according to claim 1, further comprising a control unit (9) receiving, as input, data detected by the sensors (7, 8).

11. The orthodontic extraoral traction appliance according to claim 10, wherein the control unit (9) is is adapted to compare values detected by the sensors (7, 8) with threshold values and/or ranges of reference values.

12. The orthodontic extraoral traction appliance according to claim 11, further comprising an acoustic and/or visual signalling unit (91) that receives, as the input, the data from the control unit (9) and that generates an alarm signal if the values detected by the sensors (7, 8) exceed the threshold values and/or fall outside the ranges of reference values.

13. The orthodontic extraoral traction appliance according to claim 10, further comprising a storage unit (94) for the values detected by said sensors (7, 8) that receives as input the data from the control unit (9).

14. The orthodontic extraoral traction appliance according to claim 10, further comprising a remote communication unit (92) for the values detected by said sensors (7, 8), wherein the remote communication unit receives as input the data from the control unit (9).

15. The orthodontic extraoral traction appliance according to claim 14, further comprising a web-based application for displaying data sent by the remote communication unit (92).

16. The orthodontic extraoral traction appliance according to claim 1, further comprising a system that sets the traction force exerted by the traction portions (6).

17. The orthodontic extraoral traction appliance according to claim 1, wherein the orthodontic extraoral traction appliance is configured as a face mask for correcting skeletal malocclusions in skeletal Class III, wherein the central body (1) is comprises at least one curved bar, having, in proximity of opposite ends of the curved bar, one of the rest portions (2) to be positioned on the patient's forehead and one of the rest portions (3) to be positioned on the patient's chin respectively, further comprising, in an intermediate region, an element (10) coupling the traction portions (6).

18. The orthodontic extraoral traction appliance according to claim 1, wherein the orthodontic extraoral traction appliance comprises two central bodies (1) to be arranged on the opposite sides of the patient's head, the central bodies (1) being connected together by one or more rest portions that cooperate with a back (4) and/or with a top (5) of the patient's head, the two central bodies (1) being further connected to the traction portions (6).

19. A face mask for correcting skeletal malocclusions in skeletal class III, comprising:
at least one curved bar, provided, in proximity of opposite ends of the curved bar, with a first rest portion (2) to be positioned on a patient's forehead and a second rest portion (3) to be positioned on the patient's chin, and, in an intermediate region, with a coupling element (10) coupling traction portions (6), which engage an intraoral brace; and
one or more sensors (7, 8) detecting and/or measuring a force exerted by the traction portions (6).

20. The face mask according to claim 19, wherein the sensors (7, 8) comprise pressure sensors provided within at least one of the first or second rest portions (2, 3, 4, 5).

21. The face mask according to claim 19, wherein one or more said sensors (7, 8) are provided on the coupling element (10).

22. The face mask according to claim 19, further comprising a control unit (9) comparing values detected by the sensors (7, 8) with threshold values and/or ranges of reference values.

23. The face mask according to claim 22, further comprising an acoustic and/or visual signalling unit (91) that receives, as input, data from the control unit (9) and that generates an alarm signal if the values exceed the threshold values and/or fall outside the ranges of reference values.
